(19) United States
(12) Patent Application Publication
(10) Pub. No.: US 2007/0126248 A1
(43) Pub. Date: Jun. 7, 2007

(54) Door propping method and device

(76) Inventor: Ricky Mintz, Sherman Oaks, CA (US)

Correspondence Address: JOSEPH SWAN, A PROFESSIONAL CORPORATION, 1334 PARKVIEW AVENUE, SUITE100, MANHATTAN BEACH, CA, 90266, US

(21) Appl. No.: 11/285,429

(22) Filed: Nov. 21, 2005

(51) Int. Cl. E05C 17/44

(52) U.S. Cl. 292/342

(57) ABSTRACT

A door is propped open by inserting a wedge into the space between the inner edge of the door and the door frame. The wedge preferably is substantially v-shaped, e.g., having a trapezoidal shape, and is small enough to be easily carried around. In the preferred embodiments, the wedge is made of a hard non-marking rubberlike material and has a handle for easy and safe manipulation. Optionally, a matching holder is provided for storing the wedge. Alternatively, or in addition, the handle may be configured to function as a hook for hanging the device.

### FIELD OF THE INVENTION

The present invention pertains to methods and devices for propping open a door.

### BACKGROUND

People have tried a number of different approaches to propping open a door that is biased (by mechanical force, gravity or otherwise) toward the closed position. One of the most common is to block the door open using a heavy object. Another is to use a conventional wedge-shaped doorstop that is inserted between the lower edge of the door and the floor. Unfortunately, each such technique has its own drawbacks.

For example, one cannot ordinarily count on having a heavy object around, and even if such an object is nearby it often will be difficult for certain people (e.g., children or the disabled) to manipulate. In addition, conventional doorstops that fit underneath a door often are not very effective, and also are cumbersome to manipulate into the appropriate position.

### SUMMARY OF THE INVENTION

The present invention addresses this problem by providing a technique in which a door is propped open by inserting a wedge into the space between the inner edge of the door and the door frame. Such a technique often can ensure that the door remains secured in the open position. Moreover, no bending or moving heavy objects generally is necessary with the present technique.

The wedge utilized preferably is substantially v-shaped, e.g., having a triangular or trapezoidal shape, and is small enough to be easily carried around. In the preferred embodiments, the wedge is made of a hard non-marking rubberlike material and has a handle for easy and safe manipulation. Optionally, a matching holder is provided for storing the wedge. Alternatively, or in addition, the handle may be configured to function as a hook for hanging the device.

The foregoing summary is intended merely to provide a brief description of the general nature of the invention. A more complete understanding of the invention can be obtained by referring to the claims and the following detailed description of the preferred embodiments in connection with the accompanying figures.

### BRIEF DESCRIPTION OF THE DRAWINGS

FIG. 1 is a top plan view of a wedge according to a first representative embodiment of the present invention.

FIG. 2 is a perspective view of the wedge shown in FIG. 1.

FIG. 3 is top plan view of a wedge assembly according to a second representative embodiment of the present invention.

FIG. 4 is a perspective view of the wedge assembly shown in FIG. 3.

FIG. 5 is a perspective view of the wedge assembly shown in FIG. 3, while in use.

FIG. 6 is a top plan view of the wedge assembly shown in FIG. 3, stored in a matching holder.

FIG. 7 is a bottom perspective view of the wedge assembly shown in FIG. 3, stored in a matching holder.

FIG. 8 is a top plan view of a wedge assembly according to a third representative embodiment of the present invention.

FIG. 9 is a top plan view of a wedge assembly according to a fourth representative embodiment of the present invention.

FIG. 10 is of a wedge assembly according to a fifth representative embodiment of the present invention.

FIG. 11 is of a wedge assembly according to a sixth representative embodiment of the present invention.

### DESCRIPTION OF THE PREFERRED EMBODIMENT(S)

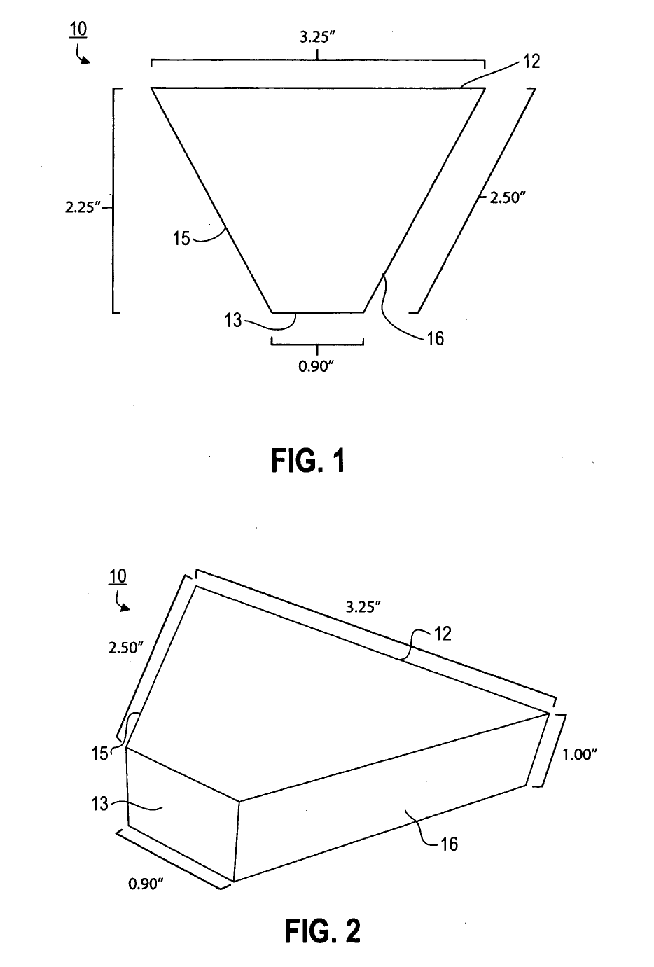

FIG. 1 shows a top plan view and FIG. 2 shows a perspective view of a wedge 10 according to a first representative embodiment of the present invention. As shown, wedge 10 has a trapezoidal shape with a wider end 12, a narrower end 13, a side 15 and an opposing side 16. In the present specific embodiment, wider end 12 is 3.25 inches long, narrower end 13 is 0.9 inch long, each of sides 15 and 16 is 2.5 inches long, the total length of wedge 10 (i.e., the distance between wider end 12 and narrower and 13) is 2.25 inches, and the angle between sides 15 and 16 is approximately 52°. More generally, wider end 12 preferably is 2-4 inches long, narrower end 13 preferably is 0-2 inches long, the total length of wedge 10 preferably is 2-6 inches, and the angle between sides 15 and 16 preferably is 30-70° or, more preferably, 40-60°.

In the preferred embodiment, wedge 10 is made of a hard rubberlike material, such as thermoplastic rubber (TPR), or any other plastic or natural or synthetic rubber. In any event, the material preferably is hard but slightly compressible and substantially resilient. Basically, the material preferably is capable of absorbing the force that will be applied to it when in use between the inner edge of a door and the door frame (as described in more detail below), without damaging either, or itself becoming dented or otherwise deformed. For similar reasons, wedge 10 preferably is made of a non-marking (e.g., substantially scuff-proof) material.

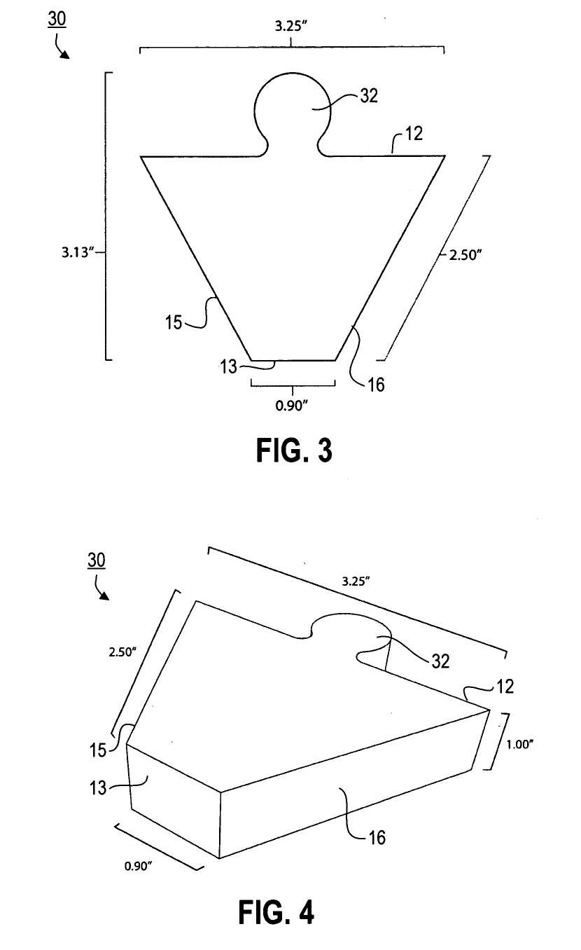

FIG. 3 is a top plan view and FIG. 4 is a perspective view of a wedge assembly 30 according to a second representative embodiment of the present invention. As shown, wedge assembly 30 is identical to wedge 10, except that wedge assembly 30 has a substantially circular knob 32 at the center of its wider end 12, allowing a user to easily manipulate wedge assembly 30. The height of handle 32 is approximately 0.9 inch, extending the length of wedge assembly 30 to 3.13 inches. More generally, handle 32 preferably is 0.75-2 inches high and 0.75-2 inches wide. The other dimensions, dimension ranges and materials mentioned above for wedge 10 also are preferred for wedge assembly 30.

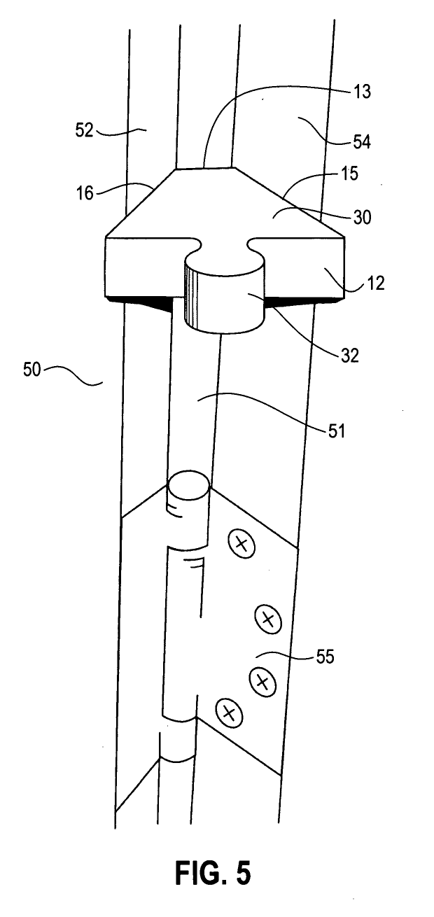

FIG. 5 is a perspective view of wedge assembly 30, while in use. More specifically, in FIG. 5 a door 50 has been opened, creating a gap 51 between the inner edge 52 of the door 50 and the door frame 54. The wedge assembly 30 has been inserted into this gap 51.

As shown in FIG. 5, door 50 is attached to door frame 54 with a hinge 55. In addition, door 50 generally will be attached with additional hinges (not shown) and may be attached via a mechanical closing mechanism (also not shown). Alternatively, door 50 might be biased toward the closed position by gravity (e.g., as a result of a tilting situation).

In the illustration of FIG. 5, the door 50 has been opened in a direction away from the viewer, as if the viewer had pushed door 50 open. From this perspective, it can be observed that gap 51 is approximately v-shaped (more specifically, trapezoidal) with the door's inner edge 52 and the door frame 54 forming the sides, so that the gap is wider closer to the viewer in the perspective of FIG. 5 and narrower in the portion further away from the viewer. As such, it will be readily appreciated that the shape of the portion of wedge assembly 30 that is inserted into gap 51 matches the shape of gap 51. In particular, the sides 15 and 16 of wedge assembly 30 abut door frame 54 and inner door edge 52, respectively. Generally speaking, the angle between sides 15 and 16 will determine how widely the door 50 remains propped open.

The operation of wedge assembly 30 is fairly straightforward. One could: (i) grab wedge assembly 30 by handle 32; (ii) open door 50 (e.g., by pushing it open) wide enough to accommodate wedge assembly 30 (e.g., creating a gap 51 that is wider than wedge assembly 30); (iii) insert wedge assembly 30 into the resulting gap 51 from the side of the door 50 from which one would push the door 50 to open it, such that the angled sides 15 and 16 are adjacent door frame 54 and inner door edge 52, respectively, and so that the narrower end 13 is deepest into the gap 51; and then (iv) allow the door 50 to close upon wedge assembly 30.

In this manner, wedge assembly 30 is held in place by the closing force of exerted on the door, by some external mechanism (not shown), by gravity or by any other force that is biasing door 50 toward the closed position. At the same time, door 50 is held open by wedge assembly 30, resulting in an equilibrium condition without any permanent attachment of wedge assembly 30 either to the door 50 or to the door frame 54.

Subsequently, when it is desired to close door 50 the user simply: (i) grasps wedge assembly 30 by handle 32; (ii) opens door 50 further to release the pressure on wedge assembly 30; (iii) withdraws wedge assembly 30; and then (iv) allows door 50 to close. As discussed in more detail below, wedge assembly 30 may then be stored for subsequent use when it again becomes necessary or desirable to prop open another door.

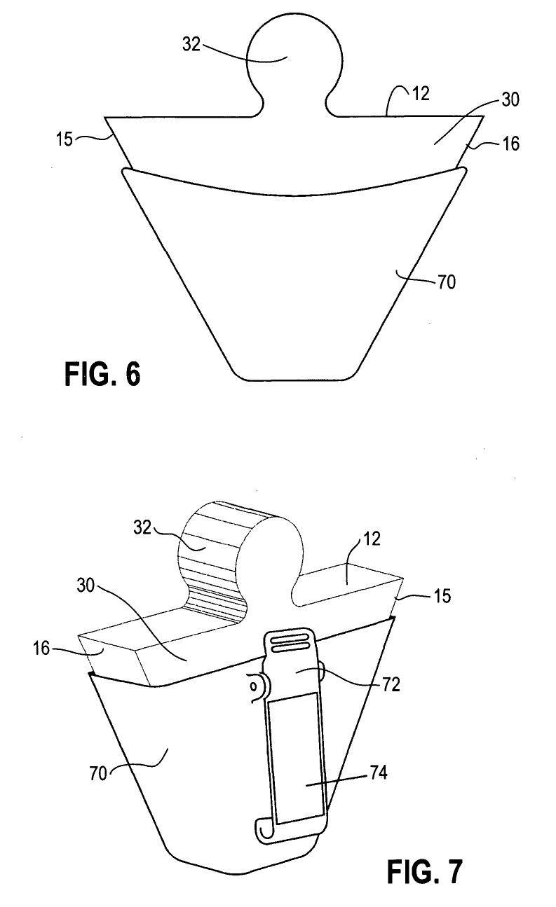

FIG. 6 is a top plan view and FIG. 7 is a bottom perspective view of the wedge assembly 30, as stored in a matching holder 70. As shown, holder 70 has a shape that matches the distal end of wedge assembly 30. In the present embodiment, a portion of wedge assembly 30, including wider end 12 and handle 32 remain outside of holder 70, even when fully inserted. At a minimum, handle 32 preferably remains outside of holder 70, to facilitate easy withdrawal.

On the bottom of holder 70 is a spring-biased clip 72, e.g., For attaching to a user's belt. In addition, clip 72 is provided with a hook or loop (e.g., Velcro) strip for attaching holder 70 to a matching strip of loops or hooks (e.g., Velcro), respectively, or to other fabric materials.

It should be understood that the holder 70 shown in FIGS. 6 and 7 and discussed above is merely exemplary. Other designs, also preferably matching the shape of at least a portion of the wedge utilized, also are contemplated. Because the wedges of the present invention preferably are small, such a holder generally will have an overall size that is approximately equivalent to that of a cell-phone holder (although the dimensions generally will be different). Accordingly, any of the designs and/or holding mechanisms (e.g., clips, straps, loops) used in cell phone holders also generally may be used for a holder according to the present invention.

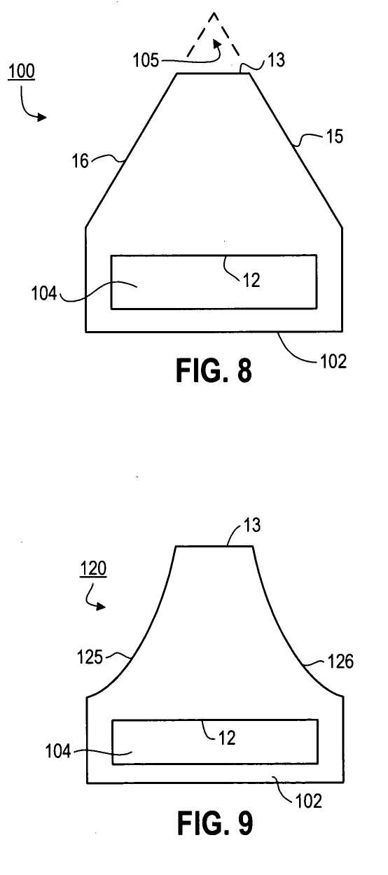

FIGS. 8-11 illustrate additional embodiments of a wedge assembly according to the present invention. Except as otherwise specifically noted below, each of the considerations above pertaining to wedge 10 and/or to wedge assembly 30 also apply to the wedge assemblies discussed below. For example, all of the preferred sizes and angles are the same with respect to the following wedge assemblies.

Initially, FIG. 8 is a top plan view of a wedge assembly 100. The specific embodiment of, and all of the considerations pertaining to, wedge assembly 30 also apply to wedge assembly 100, with the only difference being that a different handle 102 is used in wedge assembly 100. As shown, similar to handle 32, handle 102 is formed integrally with the remainder of wedge assembly 100. However, handle 102 is formed as a loop, allowing a user to wrap his or her fingers through opening 104, thereby potentially allowing for a better grip.

The angle 105 between the two sides 15 and 16 of wedge assembly 100 is clearly illustrated in FIG. 8. As noted above, this angle 105 generally determines how widely the door 50 is propped open, and preferably it is between 30-70°, more preferably between 40-60°.

As with the other embodiments, the wedge assembly 100 can be made very small, with its largest dimension being only a few inches long. In the preferred embodiment, the wedge assembly 100 is kept to such a small size, in order to make it more convenient to carry and use.

Finally, it is noted that the use of a loop-type handle 102 permits wedge assembly 100 to be hung from a hook, peg or the like. This may be in addition to or in place of using a holder such as holder 70.

FIG. 9 is a top plan view of a wedge assembly 120. As shown, wedge assembly 120 is identical to assembly 100, having a handle 102 that defines an opening 104, except that the sides 125 and 126 are curved rather than being straight. By using curved sides 125 and 126, the angle between such sides varies along the length of wedge assembly 120. It is noted that in such an embodiment, the width of the wedge portion (i.e., the distance between sides 125 and 126) often also will affect how widely the door is held open.

In the present embodiment, the angle goes from being very small (almost parallel) at the narrower distal end 13 to very large at the wider proximal end 12. Similarly, the width of the wedge goes from being very small at the narrower distal end 13 to very large at the wider proximal end 12. Accordingly, wedge assembly 120 sometimes will be better able to accommodate different types of doors. In addition, it often will be possible to control how widely the door 50 is propped open by controlling how far wedge assembly 120 is inserted into gap 51 (e.g., the further it is inserted the wider the door will be propped open).

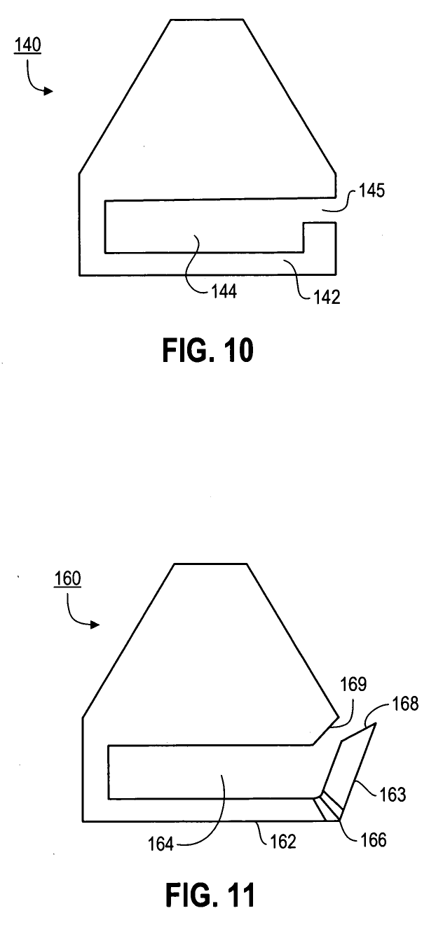

FIG. 10 is a top plan view of a wedge assembly 140. As shown, wedge assembly 140 is identical to assembly 100, except that wedge assembly 140 has a handle 142 that does not fully enclose a corresponding opening 144. Accordingly, a user still can wrap his or her fingers through opening 144. In addition, because opening 144 has a gap 145, handle 142 can itself function as a hook for hanging wedge assembly 140 from a closed loop, such as the user's belt or belt loop or a key ring.

FIG. 11 is a top plan view of a wedge assembly 160. As shown, wedge assembly 160 is identical to assembly 100, except that wedge assembly 140 has a handle 162 that includes a pivoting latch segment 163 for making the corresponding opening 164 either entirely closed in the manner of a ring (with surfaces 168 and 169 contacting each other), or partly open (as illustrated in FIG. 11). More specifically, segment 163 pivots on hinged joint 166 which preferably spring-biases latching segment 163 toward the closed position. Accordingly, a user still can wrap his or her fingers through opening 164, as is possible with wedge assembly 100.

In addition, due to the provision of pivoting segment 163, handle 162 also can function as a hook, in the same manner as the handle 142 of wedge assembly 140. Moreover, latch 163 can be opened, hooked around a loop and then subsequently closed, thereby providing a more secure hooking arrangement. It is noted that surfaces 168 and 169 may be provided with a closing mechanism (e.g., a clip or a snap-fit arrangement) instead of or in addition to spring-biasing latching segment 163 toward the closed position.

It is noted that in each of the embodiments described above, the portion of the wedge assembly that is intended for inserting into gap 51 is approximately v-shaped. In addition, in each the sides are angled toward each other in the direction of intended insertion.

Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of propping open a door, comprising:
opening a door, having an inner edge that is attached to a door frame, thereby creating a gap between the inner edge of the door and the door frame;
inserting a portion of a wedge into the space between the inner edge of the door and the door frame; and
allowing the door to close onto the wedge, thereby holding the wedge in place and maintaining the door in an open position.

2. A method according to claim 1, wherein the portion of the wedge inserted into the space between the inner edge of the door and the door frame is approximately v-shaped.

3. A method according to claim 1, wherein the portion of the wedge is inserted into the space between the inner edge of the door and the door frame from a side of the door that one would push in order to open the door.

4. A method according to claim 1, wherein the wedge comprises a handle on a side opposite the portion that is inserted into the space between the inner edge of the door and the door frame.

5. A method according to claim 4, further comprising a step of hanging the wedge by the handle.

6. A method according to claim 1, wherein the portion of the wedge inserted into the space between the inner edge of the door and the door frame is comprised of a hard, slightly compressible material.

7. A method according to claim 1, further comprising steps of further opening the door to release pressure on the wedge and then removing the wedge from the space between the inner edge of the door and the door frame.

8. A method according to claim 1, further comprising a step of storing the wedge into a holder.

9. A method according to claim 8, wherein the holder is shaped to match the portion of the wedge that is inserted into the space between the inner edge of the door and the door frame.

10. A wedge assembly for propping open a door, comprising:
a substantially v-shaped portion, having a narrow end and a wide end, comprised of a hard but slightly compressible material; and
a handle disposed at the wide end of the substantially v-shaped portion.

11. A wedge assembly according to claim 10, wherein the handle is integrally formed with the substantially v-shaped portion.

12. A wedge assembly according to claim 10, wherein the substantially v-shaped portion is at least approximately trapezoidal in shape.

13. A wedge assembly according to claim 10, wherein the material is resilient.

14. A wedge assembly according to claim 10, wherein the v-shaped portion has opposing sides between the narrow end and the wide end that form an angle of 30-70 degrees with each other.

15. A wedge assembly according to claim 14, wherein the opposing sides between the narrow end and the wide end form an angle of 40-60 degrees with each other.

16. A wedge assembly according to claim 10, wherein the v-shaped portion has opposing sides between the narrow end and the wide end that form an angle of variable size with each other, depending upon proximity to the wide end.

17. A wedge assembly according to claim 10, wherein the material is non-marking.

18. A wedge assembly according to claim 10, wherein the material is at least one of rubber, synthetic rubber or plastic.

19. A wedge assembly according to claim 10, further comprising a holder shaped to match the portion of the substantially v-shaped portion.

20. A wedge assembly according to claim 10, wherein the handle functions a hook for hanging the wedge assembly.
